(19) United States
(12) Patent Application Publication
(10) Pub. No.: US 2013/0124686 A1
(43) Pub. Date: May 16, 2013

(54) System and a Method for Sharing Computing Resources Associated to Scientific Publications

(71) Applicants: Christophe HURLIN, Orleans (FR); Gilbert COLLETAZ, Saint Cyr en Val (FR); Christophe PERIGNON, Cernay La Ville (FR); Yvan STROPPA, Neuvy en Sullias (FR)

(72) Inventors: Christophe HURLIN, Orleans (FR); Gilbert COLLETAZ, Saint Cyr en Val (FR); Christophe PERIGNON, Cernay La Ville (FR); Yvan STROPPA, Neuvy en Sullias (FR)

(73) Assignees: UNIVERSITÉ D'ORLÉANS, Orleans Cedex (FR); CNRS, Paris Cedex (FR)

(21) Appl. No.: 13/297,730

(22) Filed: Nov. 16, 2011

(51) Int. Cl. G06F 15/16

(52) U.S. Cl. 709/218; 709/217

(57) ABSTRACT

A system of computation tools sharing, the computing tools having been used to generate results presented in scientific publications, includes a computing tool being composed of a source code and a program execution tool whose function is to execute the program described by the said source code, and at least one server being used to memorize the computing tools, the computing tools being accessible remotely by an accessing user by the use of an Internet portal, the access to a computing tool through the Internet portal being linked to the scientific publication for which it has been used to generate results.

### FIELD OF THE INVENTION

This invention relates to a system and a method for sharing computing resources associated to scientific publications. It is particularly, but not exclusively, applicable to methods and system of knowledge sharing.

### BACKGROUND OF THE INVENTION

Researchers and engineers use scientific publications as a way to promote their work and to share their views on a given topic. Those publications may be of different types such as articles, books, technical reports, working papers, white papers, contributions to standards bodies and web pages. Communication means may be used to facilitate the access to those publications by other researchers, students or anyone interested by a scientific field or an author. As an example an internet portal such as IEEEXplore® provides web access to a wide range of scientific publications in the fields of electrical engineering, computer science and electronics.

In order to write their publications and to illustrate their work, researchers often use computation tools. Those tools may be used for example to simulate a physical phenomena or for economic modelling.

In this specification the expression computation tools embraces both the source code and the means that are required to execute it. The expression source code embraces codes that needs to be converted into an executable file and also codes that can be executed without the use of an executable file.

For example, well known computation tools that may be used for that purpose can be based on the use of the following software : Rats, Matlab®, R and Stata®.

In order to generate results, input data are required. Those input data correspond for example to one or several tables and/or to one or several files containing a set of parameters allowing to configure the execution of the considered computation tool.

The results obtained consist in digital data that may be represented in one or several tables or by using one or several graphics. The said results are then presented in a scientific publication as means of proof and/or analysis. The results obtained are also called output data in the sequel.

In this specification the expression computing resource refers to a computation tool that can be associated with a set of input data and/or output data.

A limitation to this approach is that the computation resources that have been used to generate results presented in a given scientific publication are not made available to the readers of the said publication. As a consequence, other researchers are not able to use the same tools to quickly compare the presented results with their own results.

### SUMMARY OF THE INVENTION

The invention has for object a system of computation tools sharing, the said computing tools having been used to generate results presented in scientific publications, a computing tool being composed of a source code and a program execution tool whose function is to execute the program described by the said source code, at least one server being used to memorize the computing tools. The said computing tools is accessible remotely by an accessing user by the use of an Internet portal, the access to a computing tool through the Internet portal being linked to the scientific publication for which it has been used to generate results.

According to a complementary aspect, the scientific publications are memorized in a server accessible remotely by the accessing user.

According to a complementary aspect, the program execution tool is used remotely by the accessing user in order to execute the program described by the memorized source code.

According to a complementary aspect, the program execution tool comprises a compiler.

According to a complementary aspect, the program execution tool is a tool that is able to execute directly a program from its source code.

According to a complementary aspect, a server memorizes the input data that have been used to generate the results presented in the associated publication.

According to a complementary aspect, the memorized input data are accessible to the accessing user in order to execute the program with the said inputs.

According to a complementary aspect, a shared program is executable remotely by an accessing user with the use of a set of input data generated by the said accessing user.

According to a complementary aspect, a server memorizes the input data that have been created and used to execute a shared program by accessing users.

According to a complementary aspect, the said Internet portal allows the accessing user to reach the scientific publication associated to the computing resources.

According to a complementary aspect, a user terminal is a smartphone, a laptop or a tablet PC.

According to a complementary aspect, a server memorizes documents that are describing how the computing resources may be used by accessing users, the said documents being accessible to them.

According to a complementary aspect, the Internet portal comprises means for the accessing users to generate their own set of input data.

According to a complementary aspect, the source code of the shared computing resources can be downloaded by the accessing users.

According to a complementary aspect, an input data set and its corresponding output data are stored into a memory such as a cache memory, the said data being used in order to avoid the program execution if the same input data have been already used to generate a set of output data.

According to a complementary aspect, the same set of input data can be used to execute different executable files and/or source code in order to compare a plurality of algorithms.

According to a complementary aspect, an input parameter belonging to an input data set is defined as a range of data in order to generate several output data sets.

The invention has also for object a method to share computing resources associated to scientific publications comprising the steps of :
sending to a server a source code describing a program together with a request indicating the level of sharing of the said source code, the said source code being associated to a scientific publication;
generating an executable file from the source code when required;
memorizing in a server the said executable file when required;
creating automatically a web page allowing to execute remotely the program.

According to a complementary aspect, depending on the level of sharing, an accessing user can execute the program, download the source code and/or download output data that have been memorized.

The invention has also for object a computer program product, stored on a computer readable medium comprising code means for causing a computer to implement the method described above.

The invention has also for object a server that memorizes computing tools, the said computing tools having been used to generate results presented in a scientific publication, the said computing tool being composed of a source code and a program execution tool allowing to execute the program described by the said source code, the said computing tools being accessible remotely to at least one user employing a terminal connected to the server.

### BRIEF DESCRIPTION OF THE DRAWINGS

A better understanding of the embodiments of the present invention can be obtained from the following detailed description in conjunction with the following drawings, in which :

FIG. 1 is a schematic representation of a system aiming at sharing computing resources;

FIG. 2 illustrate the sequencing of operations that can be set up when a sharing user is providing computing resources for the system;

FIG. 3 shows how shared computing resources may be used by an accessing user;

FIG. 4 gives a first example of how a computation tool may be shared and then used by an accessing user;

FIG. 5 gives a second example of how a computation tool may be shared and then used by an accessing user;

FIG. 6 shows an example of a page belonging to a companion site and allowing to share computing resources and scientific publications;

FIG. 7 gives an example of a hierarchical organisation of the pages composing a companion site.

### DETAILED DESCRIPTION

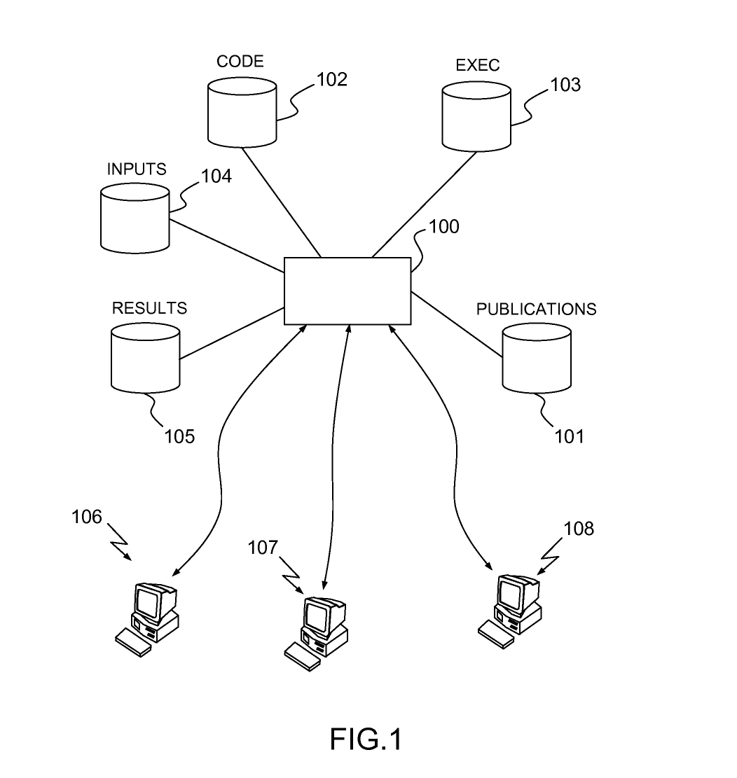

FIG. 1 is a schematic representation of a system aiming at sharing computing resources. This systems comprises a database 102 used to store a source code, a database 103 used to store executable files obtained from the said source code where appropriate. Additionally, the system includes a database 104 aiming at storing input data and a database 105 aiming at storing output data. In this specification, databases are taken as an example in order to store various kind of data. Other means such as file systems may also be used.

The system also comprises a core equipment 100 whose functions are to read and write into the said databases, to execute programs based on a source code 102 and/or an executable file 103 using input data 104. This equipment can also be used to convert source codes into an executable files when required. It is also used to manage the exchanges of data between the different components belonging to the system and one or several user terminals 106, 107, 108. As an example, an internet portal can be set up. In that case, a user may access to the services provided by the system through an Internet page.

A user terminal 106, 107, 108 is an equipment allowing a user to access to the services provided by the system. A computer connected to the system through the Internet network is an example of user terminal. A smartphone or a tablet PC are two other examples of user terminals.

There are different categories of users that may be interested by the services provided by the system. A first category embraces users who want to share their computing resources. A second category embraces users who want to access to the computing resources developed by users belonging to the first category. In the sequel, a user belonging to the first category is referred as a “sharing user” and a user belonging to the second category is referred as an “accessing user”. A user may belong to both categories at the same time.

A sharing user is a user that has developed a program and who wants to share it. It may also want to share results that have been obtained by executing this code and the input data that have been used for that purpose. In order to share his computing resources, the sharing user can create a web site called companion site. The said companion site allows an accessing user to execute a program with the input data that are made available by the sharing user or by entering his own set of input data. Additionally, the sharing user has access to one or several scientific publications for which the computing resources have been used, the said publications being memorized in the publication database 101. Alternatively, URL links can be memorized in order to allow an access to the said publications. Other kind of documents can also be shared with other users. For example, a set of documents describing how a program works can be shared.

Thus, an accessing user can use the computing resources provided by the sharing users and have an access to the related scientific publications if any.

In an embodiment, the access to the computing resources is restricted to the execution of a program 103 by using input data 104. The said input data may be already available, that is to say stored in a database 104. Alternatively, the accessing user may generate his own set of input data and launch the program.

In another embodiment, the access to the computing resources may include the access to the source code of one or several programs provided by a given sharing user. In that case, the accessing user can download, use and modify on the downloaded source code for his own use if required.

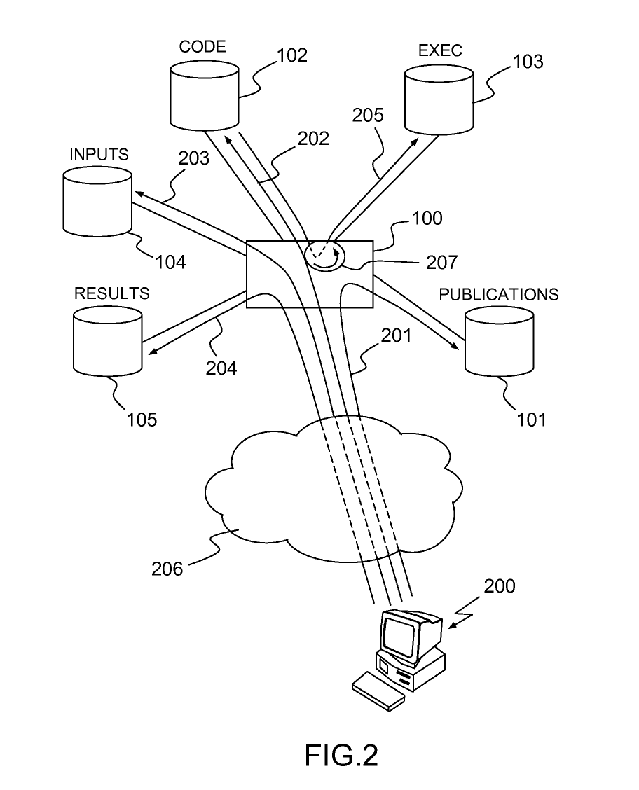

FIG. 2 illustrates the sequencing of operations that can be set up when a sharing user is providing computing resources for the system.

In this example, the sharing user has developed a program using a given programming language. The result of the programming is a source code that is comprised in one or several files. In order to share his program, the user can send 202 the said source code together with a request indicating to the system that he wants that code to be executable by anyone. For that purpose, the sharing user may use a terminal 200 connected to the system via a packet switched network 206.

Depending on the programming language, the source code may be executed directly or may need to be compiled in order to generate an executable file. As an example, a source code written in Matlab language may be interpreted directly by the Matlab software. As a remark, it is also possible to compile a source code written in Matlab language in order to obtain an executable file that can be used without using the Matlab software. In the case of a language like C or C++, a compiler will be required. As a summary, a tool is required to run a program from a source code. This tool is a compiler and/or a tool that can execute a program directly from a source code. In the sequel, this tool is called “program execution tool”.

The source code that has been sent by a sharing user is stored by the system for example in a database 102. According to the invention, the system comprises means to execute the shared source code. In the example of FIG. 1, a core equipment 100 comprises a program execution tool 207 used to generate 205 an executable file, the said file being stored into a database 103. If the sharing user has written a publication, it can also upload it 201 into the system for it to be stored with the use of a given database 101. Alternatively, an URL links can be used to access to the said publication. The sharing user can also upload 203 the input data that have been used to generate results presented in his scientific publication or any other set of input data that can be used by his program, the said data being stored in a dedicated database 104. Additionally, output data can also be uploaded 204 in order to be stored in another given database 105.

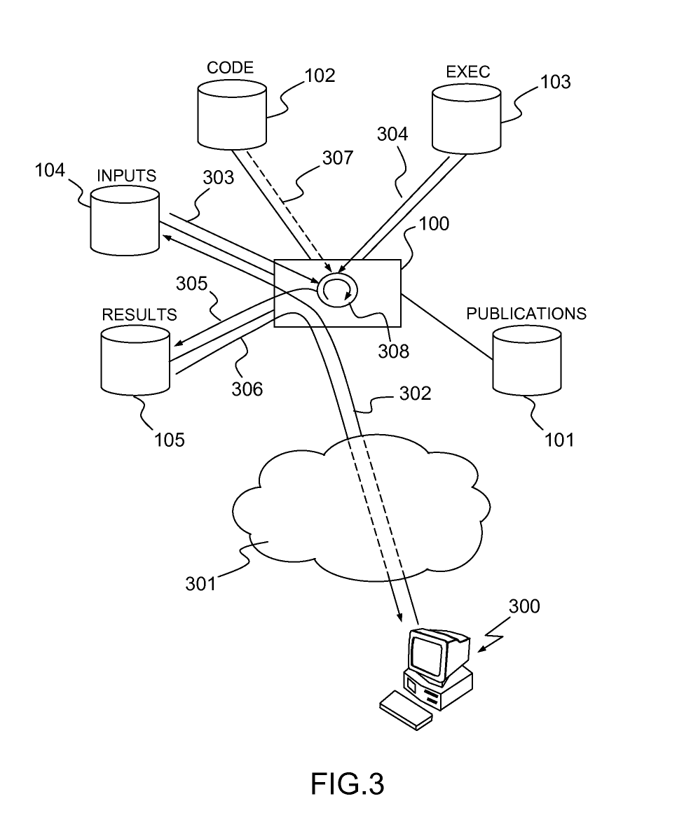

FIG. 3 shows how shared computing resources may be used by an accessing user.

As for a sharing user, an accessing user may access to the services provided by the system by using a terminal 300 connected to the said system through a telecommunication network such as a packet switched network 301. If an accessing user wants to use a program that has been developed by a sharing user, he may set up a connection with his companion site. In this example, the accessing user wants to execute a given program with the use of his own set of input data. He will begin to enter 302 the said set of data by using the interface provided by the companion site. The said input data 302 is then stored in the appropriate database 104. Then, the program will be executed. If an executable file has been generated, it is downloaded 304 by the core equipment 100 from the database 103. Then, the correct input data are used 303 to run 308 the program. Alternatively, if the program is made of a source code that can be executed directly without using an execution file, the source code is downloaded 307 by the core equipment 100. An appropriated program execution tool embedded in the core equipment 100 is then used to execute the source code. For both of those alternatives, the results obtained, that is to say the output data, are stored 305 in the database 105 and are accessible 306 to the accessing user. In a preferred embodiment, the input and the output data generated by an accessing user are available for the other accessing user through the companion site.

In another embodiment, an input data set and its corresponding output data can be stored into a memory such as a cache memory. In that case, the program will not be executed anymore if the input data have been already used to generate a set of output data.

In a preferred embodiment, the same set of input data can be used to execute different executable files and/or source code in order to compare several algorithms.

Additionally, an input parameter belonging to an input data set can be defined as a range of data in order to generate several output data sets. For example, if an input parameter A is an integer, it can be associated to the range [1; 3]. In that case, the program will be executed three times for A=1, A=2 and A=3.

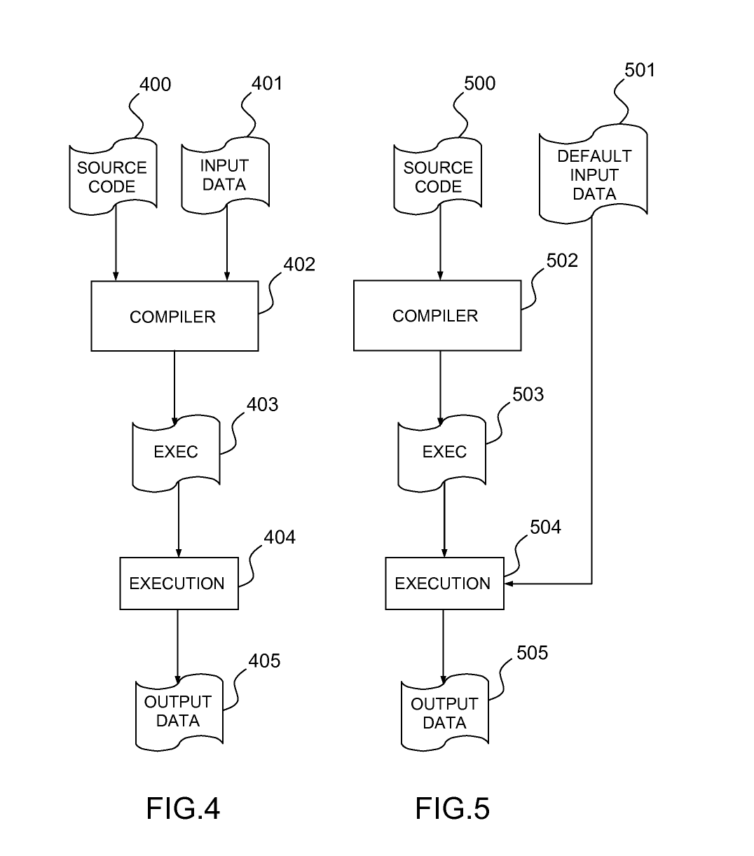

FIG. 4 gives a first example of how a computation tool may be shared and then used by an accessing user.

In this example, a sharing user has developed a source code 400 consisting of a set of scripts/files. With the aim of generating results for a publication, he has defined a set of input data 401. For the program to be executable by accessing users, an executable file should be reachable through the companion site. Depending on the programming language, a compiler 402 may be used in order to generate an executable file 403. In this example, the input data 401 are used as an input by the compiler. Thus, an accessing user may have only a limited freedom to configure the execution of the program. By accessing to the companion site associated to the appropriate computation resources, an accessing user may further execute the program 404, the generated execution file 403 being used for that purpose. The result of this execution is a set output data 405. The said data can be memorized and made accessible to other users.

FIG. 5 gives a second example of how a computation tool may be shared and then used by an accessing user.

In this example, a sharing user has developed a source code 500 consisting into a set of scripts. With the aim of generating results for a publication, he has defined a default set of input data 501. For the program to be executable by accessing users, an executable file should be reachable through the companion site. A compiler 502 may be used in order to generate an executable file 503. In this example, the input data 501 are memorized in a text file readable by the executable file of the program. This means that the said text file can be modified in order to change the parameters that are used as input data. Alternatively, other text files can be created and used by the program as input data if the same file format as the one used for the default input data is used. Thus, an accessing user may generate a new text file which allows him to configure accurately the execution of the program. An interface can be provided by the associated companion site. In that case, the accessing user does not have to know the exact format of the text file, as the interface will be in charge of facilitating the entry by the accessing users. An accessing user can then execute the program 504, the generated execution file 503 together with the file containing the default input data 501 or with another file containing another set of input data being used for that purpose. The results of this execution consist into a set of output data 405. Then the said data can be memorized and made accessible to other users.

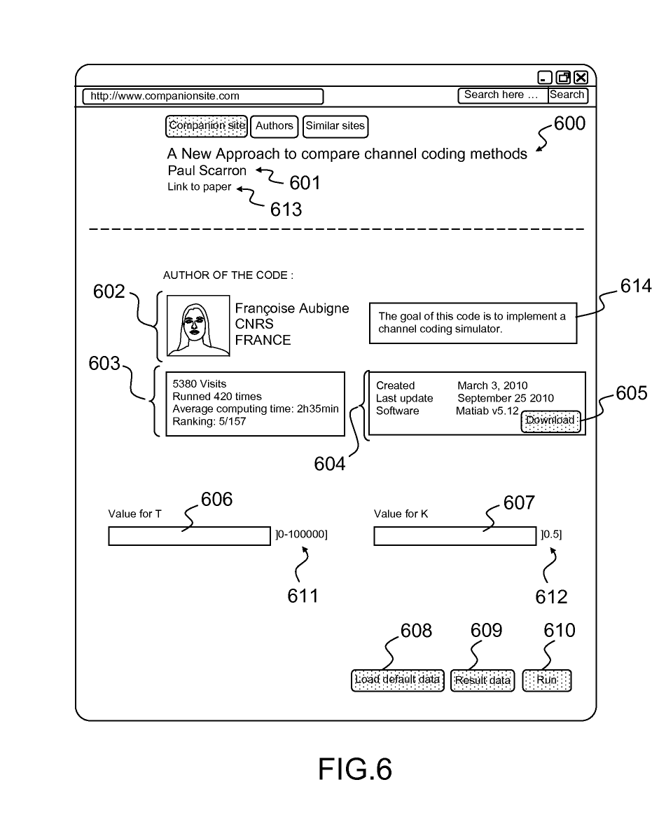

FIG. 6 shows an example of a page belonging to a companion site and allowing to share computing resources and scientific publications.

In this example, a researcher named Frangoise Aubigne 601 has created his own companion site based on a publication written by Paul Scarron entitled 600 A New Approach to Compare Channel Coding Methods. In order to generate some of the results presented in this publication, a program has been developed by Frangoise Aubigne using Matlab language. Thanks to the companion site, an accessing user can reach a page associated to this program. Information 602 related to the programmer is displayed as well as other kind of general information 603 such as the average computing time required for executing the program and a short description 614 of the program. The accessing user has the possibility to download 605 the executable file and/or the source code as allowed by the sharing user and information related to the computing tool are given 604. The accessing user can load 608 default input data or enter 606, 607 his own set of data, the required format and ranges being displayed 611, 612. The entered data can be reset 609 at any time. Once the input data have been selected, the program can be executed by pressing a button 610.

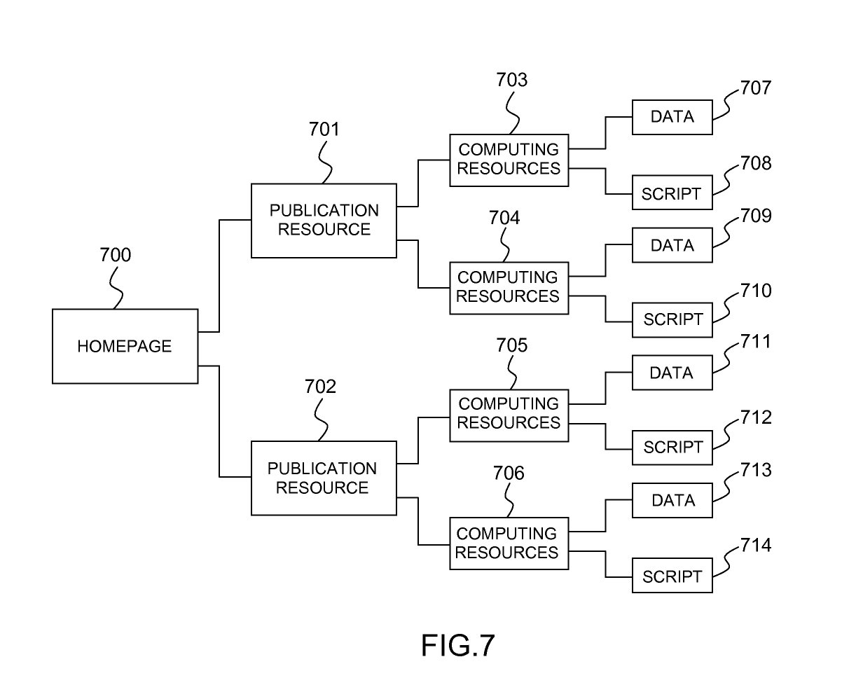

FIG. 7 gives an example of a hierarchical organisation of the pages composing a companion site. As an example, a given companion site comprises several web pages. The homepage 700 gives information on the author and provides a link to his publications. A publication resource is associated to a page 701, 702 comprising links to other pages related to the computing resources associated to the said publication. Pages 701, 702 related to a scientific publication are comprising links to associated computing resources 703, 704, 705, 706, the said computing resources being made of data 707, 709, 711, 713 and source code 707, 710, 712, 714. The companion sites can be hosted on one or several servers.

The systems and methods as described above and in the drawings are for ease of description only and are not meant to restrict the apparatus or methods to a particular arrangement or process in use.

As noted above, the system and methods described are merely exemplary and the skilled person would appreciate that a number of alternatives exist to implement the aspects of the invention. Embodiments of the invention may be also used in a wide variety of applications and contexts, wherever the sharing of computing resources may be required. It will also be apparent to the skilled person that various architectures of the system are possible within the scope of this invention as disclosed. The functions performed by the described core equipment and the described means for storing data can be spread over one or several servers connected to each other by any possible means of communication.

1- A system of sharing of computation tools, said computing tools having been used to generate results presented in scientific publications, comprising:
a computing tool being composed of a source code and a program execution tool whose function is to execute the program described by the source code,
at least one server being used to memorize the computing tools, the computing tools being accessible remotely by an accessing user by the use of an Internet portal, the access to a computing tool through the Internet portal being linked to the scientific publication for which it has been used to generate results.

2- A system according to claim 1, wherein the scientific publications are memorized in a server accessible remotely by the accessing user.

3- A system according to claim 1, wherein the program execution tool is used remotely by the accessing user in order to execute the program described by the memorized source code.

4- A system according to claim 1, wherein the program execution tool comprises a compiler.

5- A system according to claim 1, wherein the program execution tool is a tool that is able to execute directly a program from its source code.

6- A system according to claim 1, wherein a server memorizes the input data that have been used to generate the results presented in the associated publication.

7- A system according to claim 6, wherein the memorized input data are accessible to the accessing user in order to execute the program with the said inputs.

8- A system according to claim 1 ,wherein a shared program is executable remotely by an accessing user with the use of a set of input data generated by the said accessing user.

9- A system according to claim 8, wherein a server memorizes the input data that have been created and used to execute a shared program by accessing users.

10- A system according to claim 9, wherein the said Internet portal allows the accessing user to reach the scientific publication associated to the computing resources.

11- A system according to claim 1, wherein a user terminal is a smartphone, a laptop or a tablet PC.

12- A system according to claim 1, wherein the server memorizes documents that are describing how the computing resources may be used by accessing users, said documents being accessible to them.

13- A system according to claim 1, wherein the Internet portal comprises means for the accessing users to generate their own set of input data.

14- A system according to claim 1, wherein the source code of the shared computing resources can be downloaded by the accessing users.

15- A system according to claim 1, wherein an input data set and its corresponding output data are stored into a memory such as a cache memory, said data being used in order to avoid the program execution if the same input data have been already used to generate a set of output data.

16- A system according to claim 1, wherein the same set of input data can be used to execute different executable files and/or source code in order to compare a plurality of algorithms.

17- A system according to claim 1, wherein an input parameter belonging to an input data set is defined as a range of data in order to generate several output data sets.

18- A method to share computing resources associated to scientific publications, comprising:
sending to a server a source code describing a program together with a request indicating the level of sharing of said source code, said source code being associated to a scientific publication;
generating an executable file from the source code when required;
memorizing in a server the said executable file when required; and
creating automatically a web page allowing to execute remotely the program.

19- A method according to claim 18, wherein depending on the level of sharing, an accessing user can execute the program, download the source code and/or download output data that have been memorized.

20- A computer program product, stored on a computer readable medium comprising code means for causing a computer to implement the method of claim 18.

21- A server that memorizes computing tools, said computing tools having been used to generate results presented in a scientific publication, said computing tool being composed of a source code and a program execution tool allowing to execute the program described by said source code, said computing tools being accessible remotely to at least one user employing a terminal connected to the server.
